(19) United States
(12) Patent Application Publication
(10) Pub. No.: US 2006/0177224 A1
(43) Pub. Date: Aug. 10, 2006

(54) Optical add/drop multiplexer

(76) Inventor: Arkady Bablumyan, San Diego, CA (US)

Correspondence Address: GARY L. EASTMAN, EASTMAN & ASSOCIATES, 707 BROADWAY STREET, SUITE 1800, SAN DIEGO, CA, 92101, US

(21) Appl. No.: 10/856,415

(22) Filed: May 28, 2004

Related U.S. Application Data
(60) Provisional application No. 60/473,746, filed on May 28, 2003.

(51) Int. Cl. H04J 14/02

(52) U.S. Cl. 398/83

(57) ABSTRACT

A high performance method of performing an optical add/drop multiplexer function that is ideally suited for integration into a photonic integrated circuit (PIC).

### RELATED APPLICATION

This application claims the benefit of priority from Provisional Patent Application Ser. No. 60/473,746 currently co-pending.

### PROBLEM & BACKGROUND

In WDM networks (whether Course WDM, Dense WDM, or standard WDM) multiple wavelengths are propagated down a single fiber. Each wavelength contains a unique information stream (a specific information stream at a wavelength is referred to as a channel). At certain points within a network it is required to separate one or more of the wavelengths (drop function) from the through channels. At this same point one often wants to place a new information stream at the wavelengths where information was previously removed (add function). A device that removes a single wavelength from a fiber containing multiple WDM channels and adds new information at the removed wavelength is called an Add/Drop Multiplexer (ADM).

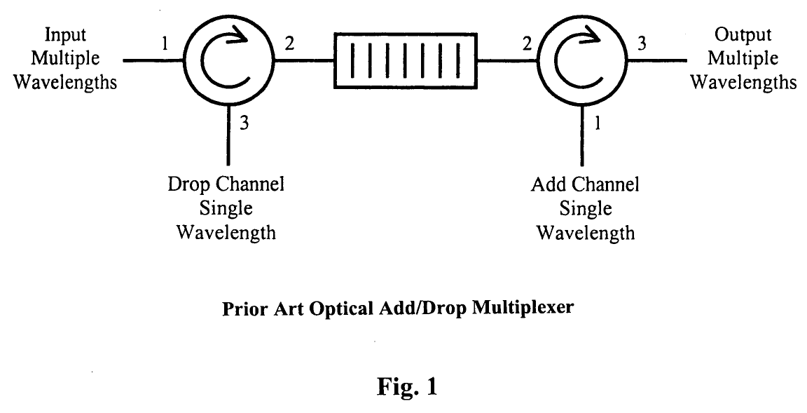

The standard ADMs in use today includes a number of discrete optical components placed in a hybrid package. FIG. 1 contains an example of one such structure.

In this device the circles represent optical circulators (themselves multiple physical parts) and the device between the circulators is a fiber Bragg grating. While these devices perform well there size is larger than desired and the complex packaging leads to a high manufacturing cost. Specifically, the circulators, which are non-reciprocal devices (they perform differently depending on the direction of the light traveling in them), are difficult to implement in a monolithic structure such as a PIC.

What is needed is an optical ADM which is can be fabricated as a monolithic device. In addition it should be small enough that multiple ADMs can be fabricated within the same PIC.

### INVENTION DESCRIPTION

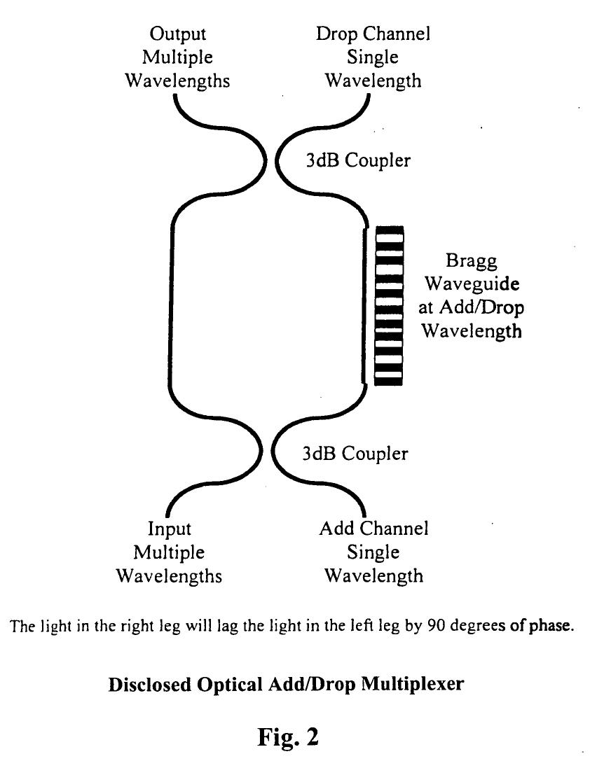

In the preferred embodiment of the invention, see FIG. 2, there are two input ports and two output ports as follows:
The two input ports appear at the bottom of the device.
The left input contains multiple channels: One of the channels may be the drop channel (it may or may not be present). If the drop channel is present this channel will be separated from the other channels. The other channels are referred to as the through channels.
The right input contains the add channel. This channel will be added to the through channels.
The two output ports appear at the top of the device.
The left output contains the through channel and the add channel.
The right output contains the drop channel.
The add and drop channels will have the same wavelength (within a small tolerance).

The key operating principle of the device is how light will couple from the right arm of the Mach-Zehnder (MZ) waveguide to the Bragg waveguide. The Bragg wavelength of the Bragg grating waveguide is at the add/drop wavelength of the device. When light at the add/drop wavelength travels down the right arm of the MZ waveguide it can not couple into the Bragg waveguide. When a channel at a wavelength that does not match the Bragg wavelength travels down the right arm of the MZ waveguide it sees the Bragg waveguide as a standard waveguide. In this case the waveguide pair (right arm of the MZ waveguide and Bragg waveguide) act as a directional coupler. Light will completely transfer from the MZ waveguide to the Bragg waveguide and then begin coupling back to the MZ waveguide. The length of the coupler is chosen such that light will transfer over and back one time (no light will be left in the Bragg waveguide). In doing this the light undergoes a 180 degree phase shift (90 degrees over and 90 degrees back). In summary the light passing down the right leg of the MZ waveguide will undergo a 180 degree phase shift (lag) if it is not at the add/drop wavelength and no phase shift if it at the add/drop wavelength.

Operation of the device for through, drop, and add channels are described below.

Through channel operation (note that the operation of one channel will be described even though many through channels may be present at the same time):
A through channel (not at the Bragg wavelength) enters the left input port.
The light is split by the input 3 dB coupler with half traveling down the left leg of the Mach-Zehnder interferometer (MZI) and half traveling down the right leg of the MZT.
The light in the right leg will couple to the Bragg waveguide as described above thus undergoing an additional 180 degree phase lag. It now lags the light in the left leg by 270 degrees.
At the output 3 dB coupler the light combines such that all light will exit the left output port of the device. This occurs as because light in the left side undergoes constructive interference while light on the right side undergoes destructive interference.

Drop channel operation:
The drop channel (at the Bragg wavelength) enters the left input port.
The light is split by the input 3 dB coupler with half traveling down the left leg of the Mach-Zehnder interferometer (MZI) and half traveling down the right leg of the MZI. The light in the right leg will lag the light in the left leg by 90 degrees of phase.
The light in the right leg will not couple to the Bragg waveguide as described above thus it undergoes no additional phase lag and remains 90 degrees behind the light the left leg.
At the output 3 dB coupler the light combines such that all light will exit the right output port of the device. This occurs as because light in the right side undergoes constructive interference while light on the left side undergoes destructive interference.
   Add channel operation:
The add channel (at the Bragg wavelength) enters the right input port.
The light is split by the input 3 dB coupler with half traveling down the left leg of the Mach-Zehflder interferometer (MZI) and half traveling down the right leg of the MZI. The light in the left leg will lag the light in the right leg by 90 degrees of phase.
The light in the right leg will not couple to the Bragg waveguide as described above thus it undergoes no phase change and remains 90 degrees ahead of the light in the left leg.
At the output 3 dB coupler the light combines such that all light will exit the left output port of the device. This occurs as because light in the left side undergoes constructive interference while light on the right side undergoes destructive-interference.

The basic operation of the structure was simulated. The results of the simulation are shown in the figures that follow. Notes relative to the simulations are as follows:
In the modeled structure inputs are placed in the bottom legs of the interferometer and outputs exit the top of the interferometer (same as described above).
Light that would pass to the Bragg leg was simulated by placing a waveguide in the Bragg leg position. Simulation of light at the Bragg wavelength was performed by moving the Bragg leg far enough away from the interferometer so that no coupling occurred.
In the pathway monitor graphs blue is the power in the left leg of the interferometer, green is the power in the right leg of the interferometer, and red is the power in the Bragg waveguide.
Note that in all figures the X-Z aspect ratio is not 1 to 1.

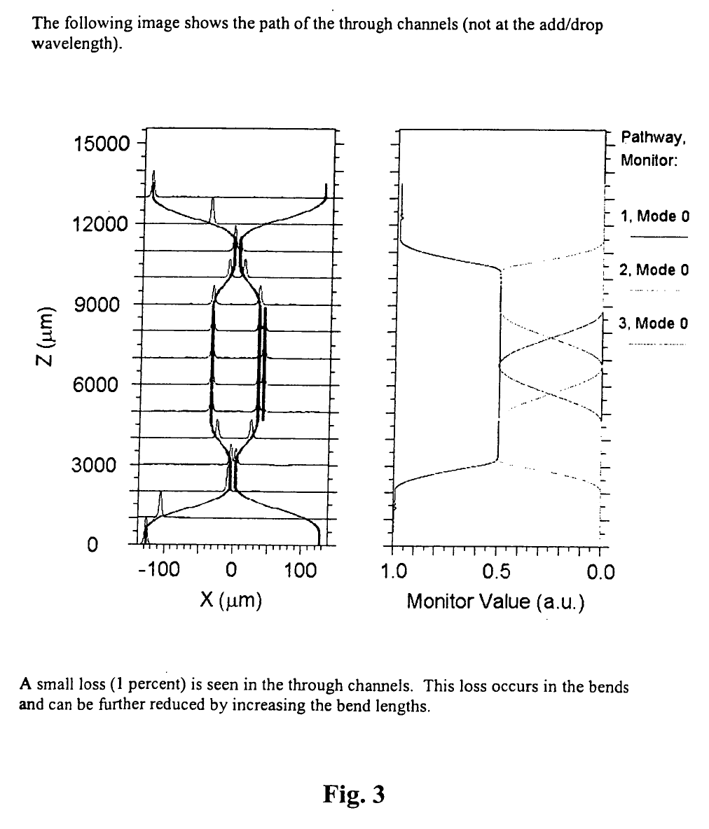

The following image in FIG. 3 shows the path of the through channels (not at the add/drop wavelength.)
A small loss (1 percent) is seen in the through channels. This loss occurs in the bends and can be further reduced by increasing the bend lengths.

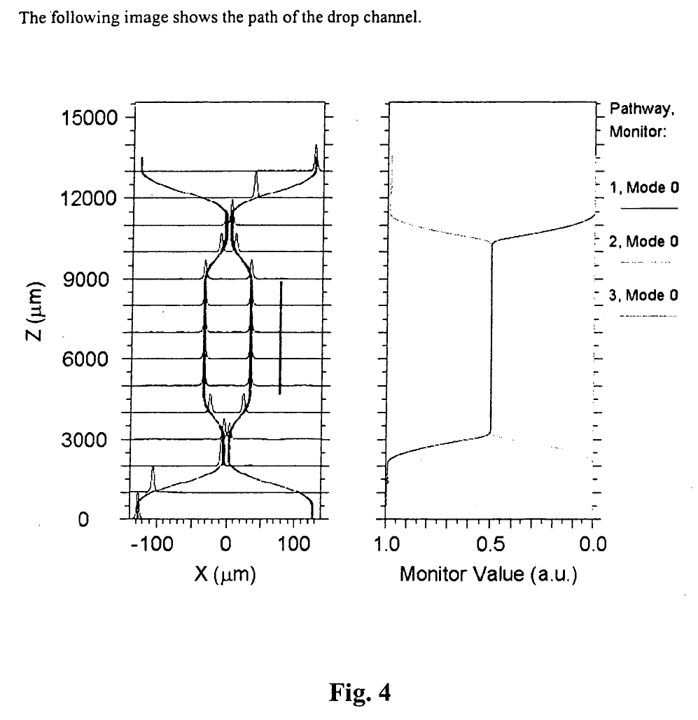

The following image in FIG. 4 shows the path of the drop channel.

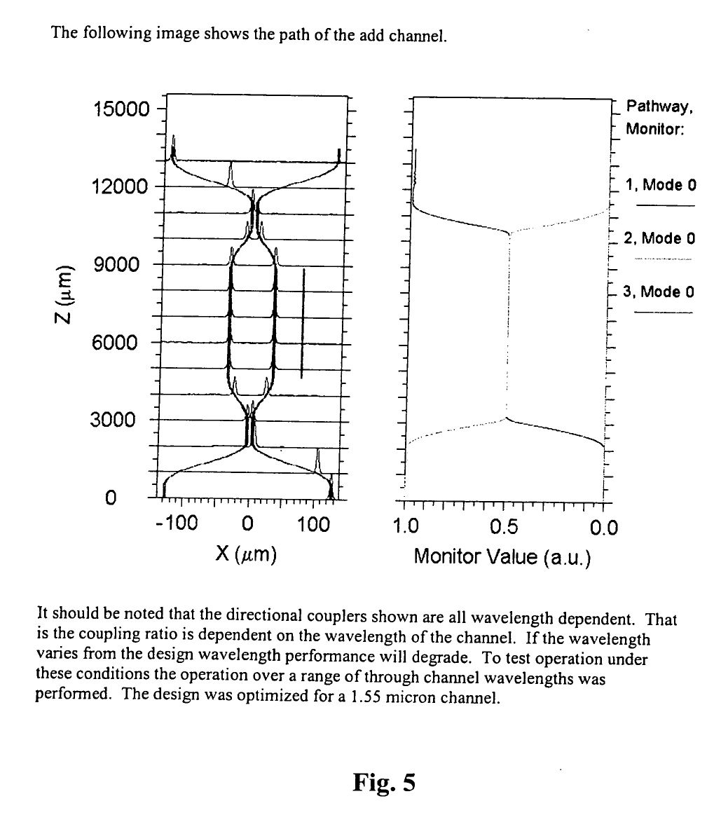

The following image in FIG. 5 shows the path of the add channel.
It should be noted that the directional couplers shown are all wavelength dependent. That is the coupling ratio is dependent on the wavelength of the channel. If the wavelength varies from the design wavelength, performance will degrade. To test operation under these conditions the operation over range of through channel wavelengths was performed. The design was optimized for a 1.55 micron channel. Operation from 1.5 microns to 1.6 microns is shown in the following figure.

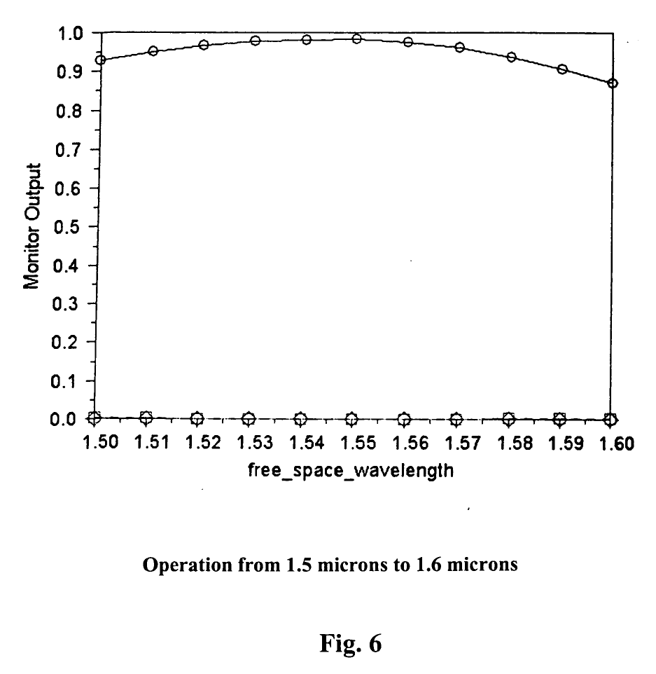

And with reference to FIG. 6:

Notes on results:
The nominal loss of the through channels is 0.1 dB at 1.55 microns.
No 1.55 micron light entered the drop channel.
The worst case loss occurs at 1.6 microns where the loss is 0.6 dB.
The 1.6 micron light that entered the drop channel was down 25 dB (good isolation).

Other enhancements to the preferred embodiment include, but are not limited to the following:
Adding a waveguide from to and/or from the Bragg waveguide to the edge of the structure such that any light left in the Bragg waveguide could be, monitored.
Placing a phase adjustment structure in the left leg of the interferometer to adjust the device for manufacturing variations.
Placing multiple ADM structures in series on the same PIC.
Enhancing the 3 dB couplers used such that they are less sensitive to wavelength variations.

I claim:

1. An optical add/drop multiplexer, comprising:
a right input port and a left input port;
said left input receiving a signal having multiple channels, wherein one of the channels is a drop channel;
said right input receiving an add channel;
a right output port and a left output port; wherein said left output contains the through channel and the add channel; and
said right output contains the drop channel.
